(19) United States
(12) Patent Application Publication
(10) Pub. No.: US 2026/0147579 A1
(43) Pub. Date: May 28, 2026

(54) INITIALIZATION VIDEO ENABLEMENT SYSTEM

(71) Applicant: Dell Products L.P., Round Rock, TX (US)

(72) Inventors: Swamy Kadaba Chaluvaiah, Round Rock, TX (US); Fernando Antonio Garcia Castillo, Hutto, TX (US)

(21) Appl. No.: 18/956,520

(22) Filed: Nov. 22, 2024

(51) Int. Cl. G06F 9/4401

(52) U.S. Cl. CPC G06F 9/4401

(57) ABSTRACT

An initialization video enablement system includes a processing system coupled to a video port by a video controller. During initialization operations, a Basic Input/Output System (BIOS) provided by the processing system identifies a processor in the processing system that is configured to control the video port. The BIOS then identifies a fabric identifier associated with the connection of the processor to the video port. The BIOS then determines a bus number assigned to the fabric identifier. The BIOS then uses the bus number to configure the video controller. The BIOS then transmits information for display on a display device via the video port using the video controller.

### BACKGROUND

The present disclosure relates generally to information handling systems, and more particularly to enabling video during the initialization of information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, are initialized before entering runtime, and one of skill in the art in possession of the present disclosure will appreciate that there are many situations in which the display of initialization status and/or other information is beneficial during the initialization of a computing device. However, enabling the display of information in computing devices during initialization can raise issues.

In conventional initialization systems, enabling the display of information in computing devices during initialization requires knowledge of a final expected configuration of the computing device in order to prevent resource overlap, resource conflict, and/or other issues that can prevent the display of information via video controllers, video ports, and/or other video subsystems in the computing device. As such, conventional initialization systems include Basic Input/Output System (BIOS) code that is generated during development of the computing device and that includes the identity of a root port on a processor that will control a video port on the computing device through which information will be transmitted for display, as well as the identity of a bus number for a bus that will connect that root port to the video port, with that BIOS code static/fixed for the computing device and executed by the its BIOS in order to enable the display of information in the computing device during its initialization.

As such, conventional initialization systems require that BIOS code that enables the display of information in computing devices during their initialization be generated for each generation of computing devices. Furthermore, different computing device configurations and capabilities can greatly increase the complexity of such BIOS code. For example, multi-processor computing devices operate to split the bus numbers of available buses between their processors, and thus the bus number of the bus that will connect the root port of a processor to the video port in a computing device will change depending on the number of processors that are provided in that computing device. Furthermore, computing devices may be configured with multi-segmentation capabilities that can greatly increase the number of available buses, and/or with bus repurposing capabilities that reassign unused buses to address resource demands. These different configurations and capabilities must be addressed by the BIOS code in conventional initialization systems in order to enable the display of information in the computing device during its initialization, or may result in computing devices with particular configurations and/or capabilities being unable to display information during their initialization.

Accordingly, it would be desirable to provide an initialization video enablement system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a Basic Input/Output System (BIOS) that is configured, during initialization operations for the IHS, to: identify a processor that is included in the processing system and that is configured to control a video port; identify a fabric identifier that is associated with the connection of the processor to the video port; determine a bus number that is assigned to the fabric identifier; configure, using the bus number, a video controller; and transmit, via the video port using the video controller, information for display on a display device.

### BRIEF DESCRIPTION OF THE DRAWINGS

FIG. 1 is a schematic view illustrating an embodiment of an Information Handling System (IHS).

FIG. 2 is a schematic view illustrating an embodiment of a computing device that may provide the initialization video enablement system of the present disclosure.

FIG. 3 is a flow chart illustrating an embodiment of a method for enabling video during initialization of a computing device.

FIG. 4 is a schematic view illustrating an embodiment of the computing device of FIG. 2 operating during the method of FIG. 3.

FIG. 5 is a schematic view illustrating an embodiment of the computing device of FIG. 2 operating during the method of FIG. 3.

FIG. 6 is a schematic view illustrating an embodiment of the computing device of FIG. 2 operating during the method of FIG. 3.

FIG. 7 is a schematic view illustrating an embodiment of the computing device of FIG. 2 operating during the method of FIG. 3.

FIG. 8 is a schematic view illustrating an embodiment of the computing device of FIG. 2 operating during the method of FIG. 3.

FIG. 9 is a schematic view illustrating an embodiment of the computing device of FIG. 2 operating during the method of FIG. 3.

FIG. 10 is a schematic view illustrating an embodiment of the computing device of FIG. 2 operating during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

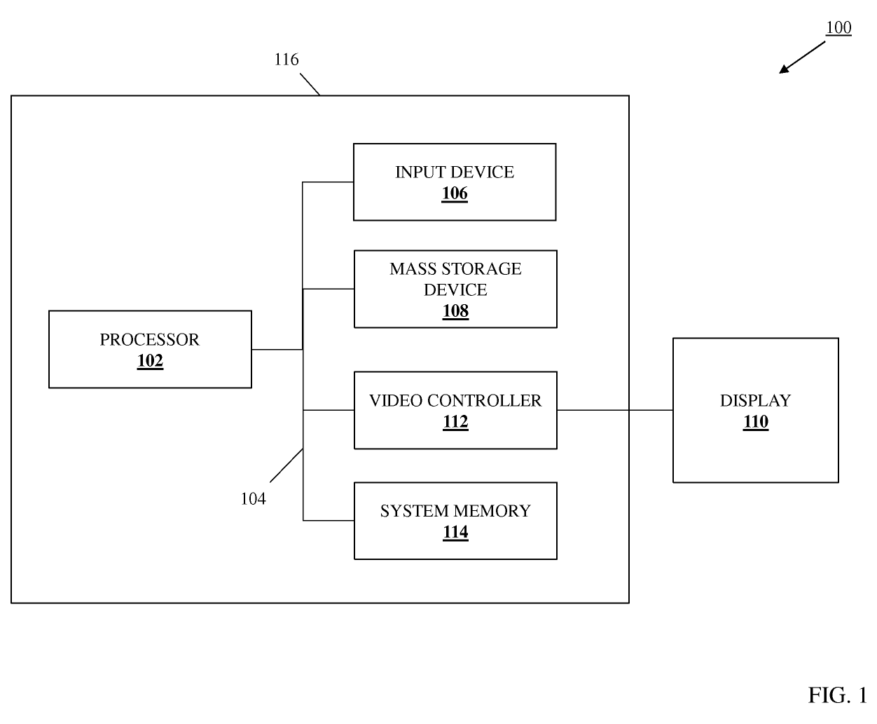

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

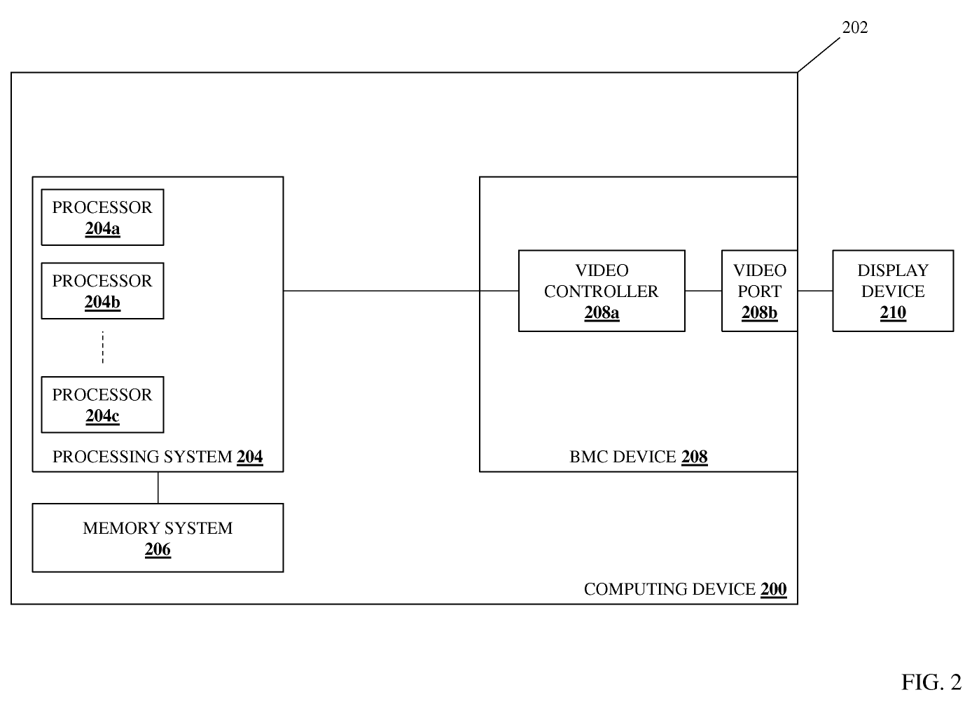

Referring now to FIG. 2, an embodiment of a computing device 200 is illustrated that may provide the initialization video enablement system of the present disclosure. In an embodiment, the computing device 200 may be provided by the IHS 100 discussed above with reference to FIG. 1, and/or may include some or all of the components of the IHS 100, and in specific examples discussed below is provided by a server device. However, while illustrated and discussed as being provided by a server device, one of skill in the art in possession of the present disclosure will recognize that computing devices providing the initialization video enablement system of the present disclosure may be provided by networking devices (e.g., switch devices, access points, etc.), storage systems, desktop computing devices, laptop/notebook computing devices, tablet computing devices, mobile phones, and/or other computing devices that one of skill in the art in possession of the present disclosure will recognize may be configured to operate similarly as the computing device 200 discussed below.

In the illustrated embodiment, the computing device 200 includes a chassis 202 that houses the components of the computing device 200, only some of which are illustrated and described below. For example, the chassis 202 may house a processing system 204. In the examples illustrated and described below, the processing system 204 includes a plurality of processors 204a, 204b, and up to 204c (e.g., each of which may provide the processor 102 discussed above with reference to FIG. 1 such as, for example, a Central Processing Unit (CPU)). However, while a multi-processor processing system 204 is illustrated and described, one of skill in the art in possession of the present disclosure will appreciate how the initialization video enablement system of the present disclosure may operate with single-processor processing systems while remaining within the scope of the present discloser as well.

The chassis 202 also houses a memory system 206 (e.g., which may provide the memory 114 discussed above with reference to FIG. 1) that is coupled to the processing system 204 and that, as discussed below, includes instructions that, when executed by the processing system 204, cause the processing system 204 to provide a Basic Input/Output System (BIOS) that is configured to perform the functionality of the BIOS and/or computing devices discussed below. In the illustrated example, the chassis 202 also houses a Baseboard Management Controller (BMC) device 208 that is coupled to the processing system 204 and that may be provided by an integrated Remote Access Controller (iDRAC) device that may be included in server devices available from DELL® Inc. of Round Rock, Texas, United States, as well as other BMC devices that would be apparent to one of skill in the art in possession of the present disclosure. As such, one of skill in the art in possession of the present disclosure will appreciate how the BMC device 208 may provide Out-Of-Band (OOB) management for the computing device 200 using mostly separate resources from the computing device 200 and via a browser-based interface or Command-Line Interface (CLI) that provides for management and monitoring of hardware in the computing device 200.

In the examples illustrated and provided below, the BMC device 208 includes a video controller 208a that is coupled to the processing system 204, and a video port 208b that is coupled to the video controller 208a. As will be appreciated by one of skill in the art in possession of the present disclosure, the video controller 208a in the BMC device 208 may be considered to be provided “behind”, or “embedded” in, the BMC device 208. Iin a specific example, the video port 208b may be provided by a Video Graphics Array (VGA) port that one of skill in the art in possession of the present disclosure will recognize is configured to connect to display devices, although other videos ports will fall within the scope of the present disclosure as well. However, while illustrated as being included in the BMC device 208, one of skill in the art in possession of the present disclosure will appreciate how the video controller 208a and video port 208b may be provided in the computing device 200 in a variety of manner that will fall within the scope of the present disclosure as well.

As illustrated, a display device 210 may be coupled to the video port 208b. However, while the embodiments illustrated and described herein involve a display device connected to a video port on a server device, one of skill in the art in possession of the present disclosure will appreciate of the initialization video enablement system of the present disclosure may enable video for display on a display device during the initialization of a computing device via a network and/or using a variety of other computing device/display device configurations while remaining within the scope of the present disclosure.

As will be appreciated by one of skill in the art in possession of the present disclosure, in the specific examples provided herein, the processing system 204 is described as being provided by (or being similar to) a multi-processor processing system available from Advanced Micro Devices (AMD) Inc. of Santa Clara, California, United States. For example, the computing device 200 is described below as being capable of utilizing an AMD processing system having one processor or an AMD processing system having two processors, and being configurable with Peripheral Component Interface (PCI) multi-segmentation capabilities and/or bus repurposing capabilities.

As discussed above, when a two-processor AMD processing system is provided in the computing device 200, the bus numbers of available buses in the computing device 200 will be split between those processors, and thus the bus number of the bus that will connect a root port of a processor in the processing system of the computing device 200 to the video port 208b will change depending on whether the one-processor AMD processing system or the two-processor AMD processing system are provided in the computing device 200. In addition, the PCI multi-segmentation capabilities of the AMD processing system can greatly increase the number of available buses in the computing device 200, and the bus repurposing capabilities of the AMD processing system may reassign unused buses in the computing device 200 to address resource demands in the computing device 200. As such, the ability to utilize either of the one-processor and two-processor AMD processing systems discussed above in the computing device 200 introduces a variety of variability and complexity in the PCI topology (and thus the expected final configuration) of the computing device 200 that is required to enable video during the initialization of the computing device 200.

However, while a specific computing device 200 has been illustrated and described, one of skill in the art in possession of the present disclosure will recognize that computing devices (or other devices operating according to the teachings of the present disclosure in a manner similar to that described below for the computing device 200) may include a variety of components and/or component configurations for providing conventional computing device functionality, as well as the initialization video enablement functionality discussed below, while remaining within the scope of the present disclosure as well. As discussed below, the systems and methods of the present disclosure eliminate the need to know the final expected configuration of the computing device 200 in order to prevent resource overlap, resource conflicts, and/or other issues when enabling video during initialization of the computing device 200, thus simplifying the BIOS code needed to do so and eliminating the need to change that BIOS code across each generation of computing devices.

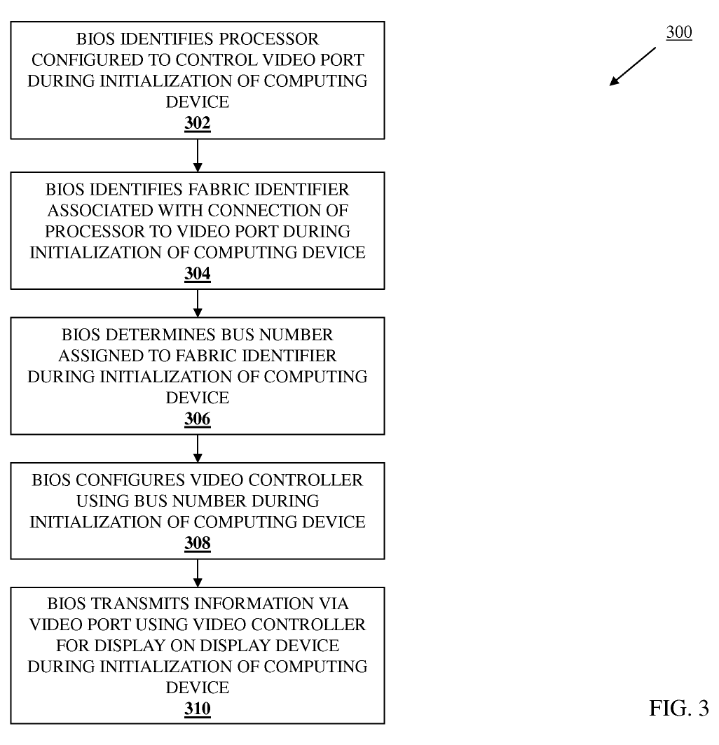

Referring now to FIG. 3, an embodiment of a method 300 for enabling video during initialization of a computing device is illustrated. As discussed below, the systems and methods of the present disclosure take advantage of a fixed mapping of a fabric identifier to the connection between a video port and a processor that controls that video port in order to identify a bus number associated with that fabric identifier, and then use that bus number to configure a video controller that is coupled to the video port and that allows information to be transmitted via the video port for display on a connected display device during initialization operations. For example, the initialization video enablement system of the present disclosure may include a processing system coupled to a video port by a video controller. During initialization operations, a Basic Input/Output System (BIOS) provided by the processing system identifies a processor in the processing system that is configured to control the video port. The BIOS then identifies a fabric identifier associated with the connection of the processor to the video port. The BIOS then determines a bus number assigned to the fabric identifier. The BIOS then uses the bus number to configure the video controller. The BIOS then transmits information for display on a display device via the video port using the video controller. As such, video may be dynamically enabled during the initialization of a computing device without having to take into account the different configurations and capabilities of processing systems that are available for utilization with that computing device.

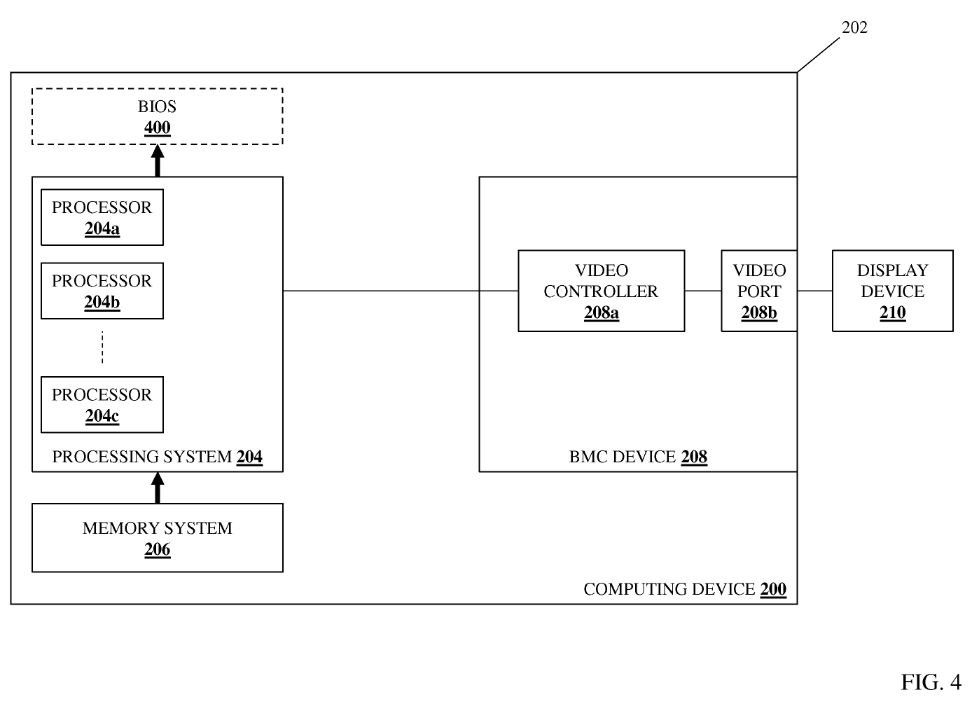

The method 300 begins at block 302 where a BIOS identifies a processor that is configured to control a video port during initialization of a computing device. With reference to FIG. 4, during or prior to the method 300, the computing device 200 may be powered on, booted, reset, rebooted, and/or otherwise initialized such that the processing system 204 executes BIOS instructions that are stored on the memory system 206 in order to provide a BIOS 400 that is configured to perform the functionality of the BIOS 400 described above. As will be appreciated by one of skill in the art in possession of the present disclosure, the BIOS 400 may be configured to perform hardware initialization operations during the initialization (e.g., a Power-on Start-up (POST)) of the computing device 200, runtime services for an operating system and/or applications provided by the computing devices, and/or other BIOS operations known in the art. Furthermore, while illustrated and described as being provided by a “BIOS”, one of skill in the art in possession of the present disclosure will appreciate how the BIOS 400 may be provided according to the Unified Extensible Firmware Interface (UEFI) specifications that define an architecture for firmware used for initializing hardware in a computing device, and its interface with operating systems provided by computing devices.

In an embodiment, the method 300 may be performed during a Pre-Extensible Firmware Interface (EFI) Initialization (PEI) phase of the initialization of the computing device 200 that occurs after a SECurity (SEC) phase of the initialization of the computing device 200 and prior to a Driver eXecution Environment (DXE) phase of the initialization of the computing device 200 in order to enable “early” video during the initialization of the computing device 200, although one of skill in the art in possession of the present disclosure will appreciate how the techniques described herein may be performed during other stages of the initialization of the computing device 200 while remaining within the scope of the present disclosure as well.

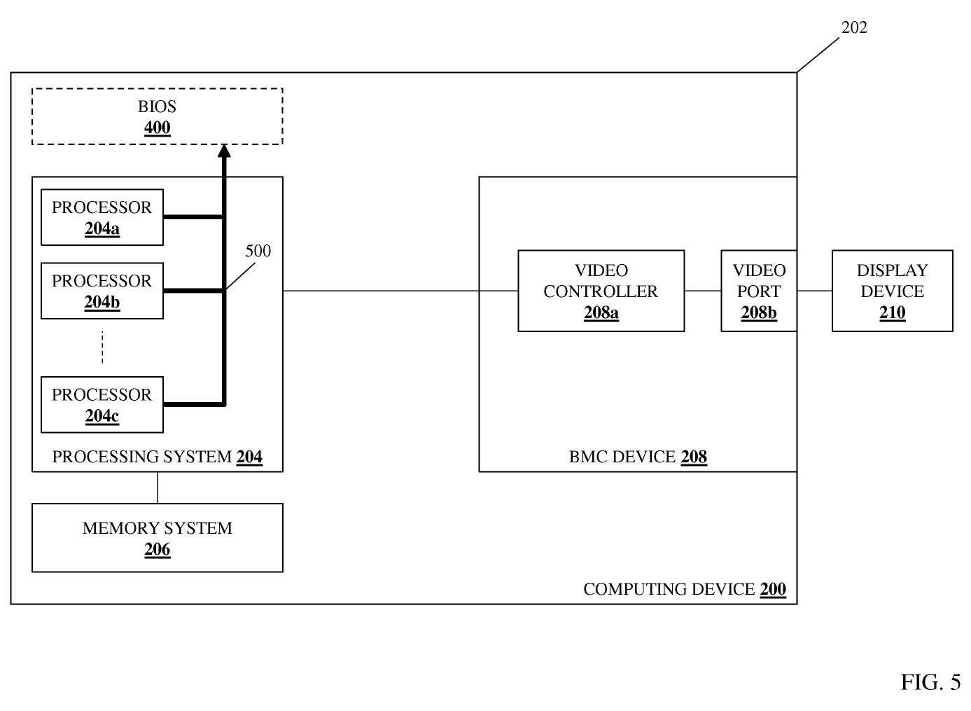

With reference to FIG. 5, in an embodiment of block 302, the BIOS 400 may perform processor identification operations 500 that may include accessing any or all of the processors 204a-204c in the processing system 204 to identify one of those processors that is configured to control the video port 208b provided by the BMC device 208. For example, at block 302, the processor identification operations 500 may include the BIOS 400 identifying the one of the plurality of processors 204a-204c in the processing system 204 that has a video port enable field (e.g., a “VGA enable” field) set in one of its registers (e.g., via the provisioning of a flag, bit, or other data in the video port enable field), and one of skill in the art in possession of the present disclosure will appreciate how the video port enable field may have been set in the register of a processor prior to the execution of the BIOS code to provide the BIOS 400. Continuing with the specific example in which the processing system 204 is an AMD processing system, the video port enable field in the register of a processor may be set while in an AMD-specific initialization environment in which the processing system 204 does not transfer any information to the BIOS 400, thus necessitating the reading of the registers in the processor(s) to enable video as described below.

In the example below, the processor 204b is identified as being configured to control the video port 208b based on one of its registers including a video port enable field (e.g., a “VGA enable” field) set, but one of skill in the art in possession of the present disclosure will appreciate how any one of the processors in the processing system 204 may be identified as having been configured to control the video port 208b at block 302 in a similar manner while remaining within the scope of the present disclosure as well. As such, while the BIOS 400 is illustrated as accessing all of the processors 204a-204c in the processing system 204 to identify one of those processors that is configured to control the video port 208b, one of skill in the art in possession of the present disclosure will appreciate how the BIOS 400 may access the processors in the processing system 204 sequentially and may stop accessing processors in the processing system 204 when one has been identified as being configured to control the video port 208b (i.e., after accessing the processor 204a and determining that it is not configured to control the video port 208b, the BIOS 400 may access the processor 204b and determine that it is configured to control the video port 208b, and then may stop accessing processors in the processing system 200) because only one processor in the processing system 200 will be configured to control the video port 208b.

However, while specific techniques for identifying which of a plurality of processors in a processing system is configured to control a video port have been described, one of skill in the art in possession of the present disclosure will appreciate how one of a plurality of processors may be identified as being configured to control a video port using other techniques that will fall within the scope of the present disclosure as well. Furthermore, one of skill in the art in possession of the present disclosure will appreciate how block 302 may be performed similarly as described above in a one-processor processing system (i.e., as the one processor in that processing system will be identified as being configured to control the video port similarly as described above for the processor 204b).

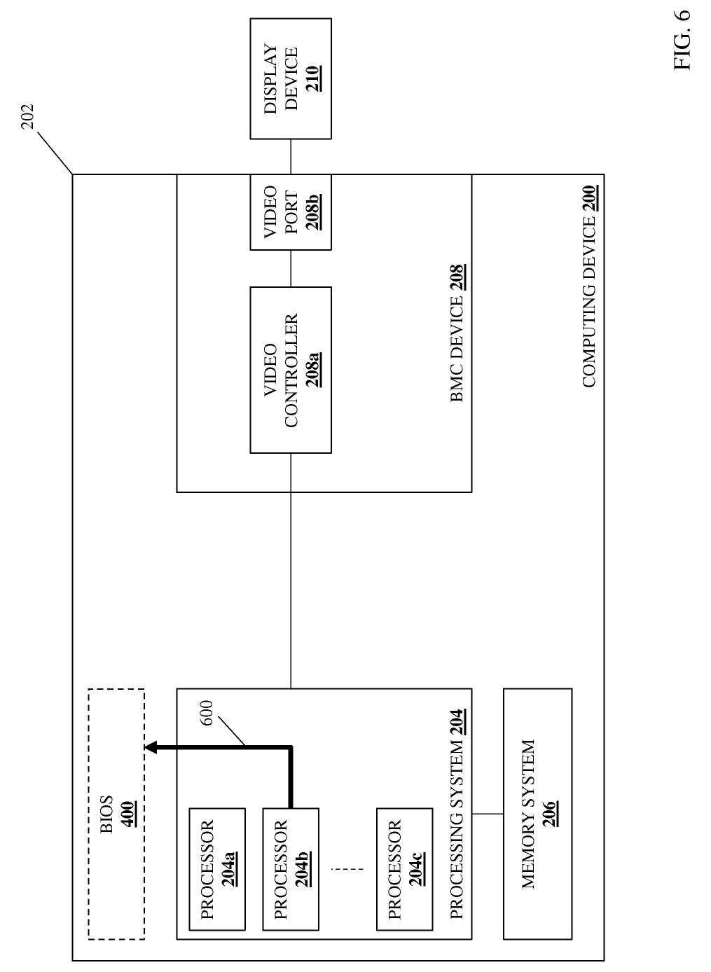

The method 300 then proceeds to block 304 where the BIOS identifies a fabric identifier associated with a connection of the processor to the video port during the initialization of the computing device. With reference to FIG. 6, in an embodiment of block 304, the BIOS 400 may perform fabric identifier identification operations 600 that may include accessing the processor 204b that was identified as being configured to control the video port 208b in order to identify a fabric identifier (e.g., a destination fabric identifier (“DstFabricId”)) that is associated with a root port on the processor 204b that is connected via a Peripheral Component Interconnect express (PCIe) link to the video port 208b. Continuing the example above in which the processing system 204 is an AMD processing system, the register in the processor 204 (e.g., an initialized internal fabric register) that has the video port enable field (e.g., the “VGA enable” field) set may be programmed with the fabric identifier prior to the execution of the BIOS code to provide the BIOS 400 as described above, and at block 304 the BIOS 400 may read the fabric identifier from that register.

As will be appreciated by one of skill in the art in possession of the present disclosure, the fabric identifier programmed in the register of the processor that has the video port enable field set will have a fixed mapping to the root port of that processor and the PCIe link between that root port and the video port 208b, and will not change based on the number of processors included in the processing system 204 or the performance of PCI multi-segmentation operations and/or bus repurposing operations discussed above. Continuing with the specific example in which the processing system 204 is an AMD processing system, the fabric identifier may be an AMD-specific identifier that is associated with a block from which PCI links to various components are available, with the AMD processing system determining the mapping and identifiers for those PCI links based on generation, model, Stock Keeping Unit (SKU), and/or other details of the AMD processing system. As will be appreciated by one of skill in the art in possession of the present disclosure, the mappings discussed above are typically fixed, but if such mappings change during development of the AMD processing systems, those changes may be communicated so that the systems and methods of the present disclosure may be adjusted as needed to operate as described herein.

As will be appreciated by one of skill in the art in possession of the present disclosure, the identification of the fabric identifier programmed in the register of the processor that was identified as being configured to control the video port 208b allows for the dynamic enablement of video during initialization of the computing device 200. However, in processing systems that do not program the register of their processor that is configured to control the video port 208b with a fabric identifier that is associated with a root port on that processor that is connected via PCIe link to the video port 208b, that fabric identifier may be provided (e.g., during BIOS development) in the BIOS code that is stored in the memory system 206 and used to provide the BIOS 400 as described above, and at block 304 BIOS 400 may identify that fabric identifier in that BIOS code.

As will be appreciated by one of skill in the art in possession of the present disclosure, if the fabric identifier is identified in the BIOS code as described above, there will be no need to identify the video port enable field as described above. Continuing with the specific example in which the processing system 204 is an AMD processing system, in such embodiments the registers including the fabric identifier information and the video port enable field may be cleared before the AMD initialization sequence transfers control to the BIOS 400, and the BIOS 400 may set the video port enable field for the fabric identifier, and read the bus information including “base” bus number for the fabric identifier as described below However, while a few specific examples of the identification of the fabric identifier have been provided, one of skill in the art in possession of the present disclosure will appreciate how the fabric identifier and/or the connections between the video port 208b and the processor that controls that video port 208b may be identified using other techniques that will fall within the scope of the present disclosure as well.

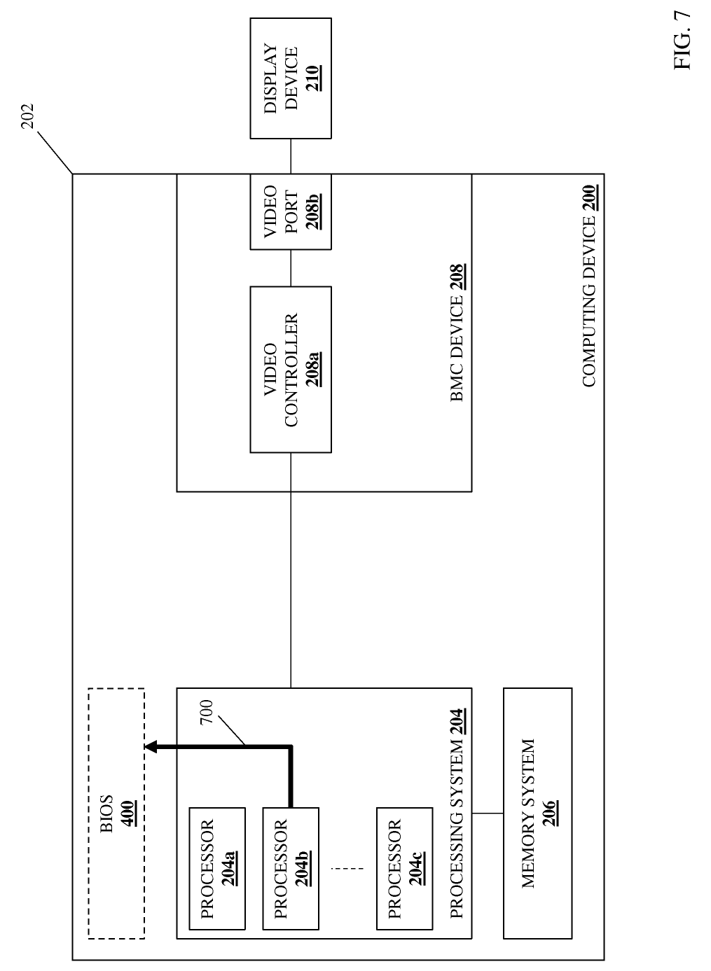

The method 300 then proceeds to block 306 where the BIOS determines a bus number assigned to the fabric identifier during the initialization of the computing device. With reference to FIG. 7, in an embodiment of block 306, the BIOS 400 may perform bus number determination operations 700 that include determining a bus number that is assigned to the fabric identifier that was identified at block 304. For example, at block 306, the bus number determination operations 700 may include the BIOS 400 accessing a configuration base address (“CfgBaseAddress”) register and a configuration limit (“CfgLimit”) in the processor 204b that are being used to configure bus resources in the computing device 200 for the fabric identifier identified at block 304 in order to determine a base address and an upper boundary for a configuration space for that fabric identifier, which one of skill in the art in possession of the present disclosure will appreciate allows the BIOS 400 to identify a range of bus numbers (e.g., PCIe bus numbers) that are assigned to the PCIe link that is associated with the fabric identifier identified at block 304 and that connects the root port of the processor 204b associated with that fabric identifier to the video port 208b.

As will be appreciated by one of skill in the art in possession of the present disclosure, the base address determined from the configuration base address register in the processor 204b may identify the bus number (e.g., a PCIe bus number) that should be used by the video port 208b. For example, the range of bus numbers assigned to the PCIe link that is associated with the fabric identifier identified at block 304 may include bus numbers “20-40”, with the “base” bus number (e.g., “20”) being the first bus number in that range of bus numbers that will be assigned to the root port in the processor 204c that is connected via the PCIe link to the video port 208b, and thus bus number “20” in the range of bus numbers “20-40” that are assigned to the fabric identifier identified at block 304 may be determined by the BIOS 400 at block 306. However, while a specific example of the determination of a bus number assigned to a fabric identifier has been provided, one of skill in the art in possession of the present disclosure will appreciate how the determination of a bus number assigned to the fabric identifier identified at block 304 may be performed using other techniques that will fall within the scope of the present disclosure as well.

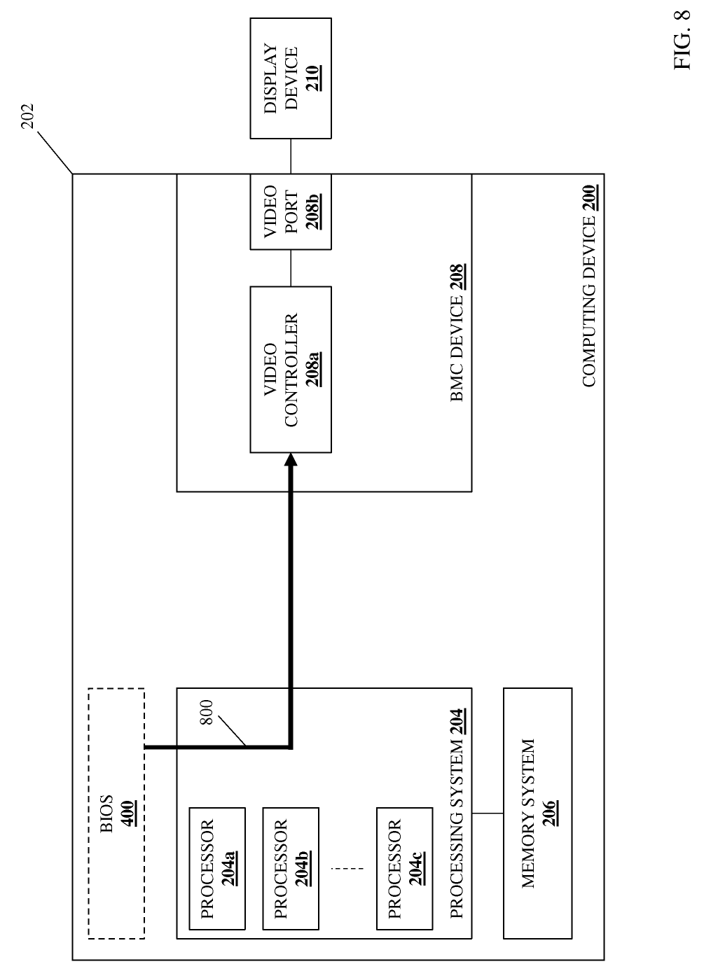

The method 300 then proceeds to block 308 where the BIOS configures a video controller using the bus number during the initialization of the computing device. With reference to FIG. 8, in an embodiment of block 308, the BIOS 400 may perform video controller configuration operations 800 that include using the bus number determined at block 306 to configure the video controller 208a in the BMC device 208. For example, at block 308, the BIOS 400 may use the bus number (e.g., a PCIe bus number) determined at block 306 to configure the BMC device 208 by assigning primary, secondary, and subordinate bus numbers in the BMC device 208, which one of skill in the art in possession of the present disclosure will appreciate will allow the BIOS 400 to discover and configured the video controller 208a that is “embedded” or “behind” the BMC device 208. Following discovery, the configuration of the video controller 208a by the BIOS 400 may include enabling a master bit (e.g., in a bus master enable field in a command register included in PCI configuration registers) and a memory bit (e.g., in a memory enable field in a command register included in PCI configuration registers) in the video controller 208a (e.g., to activate the video controller 208a and initiate communications with the video controller 208a), and/or perform any other video controller configuration operations that would be apparent to one of skill in the art in possession of the present disclosure.

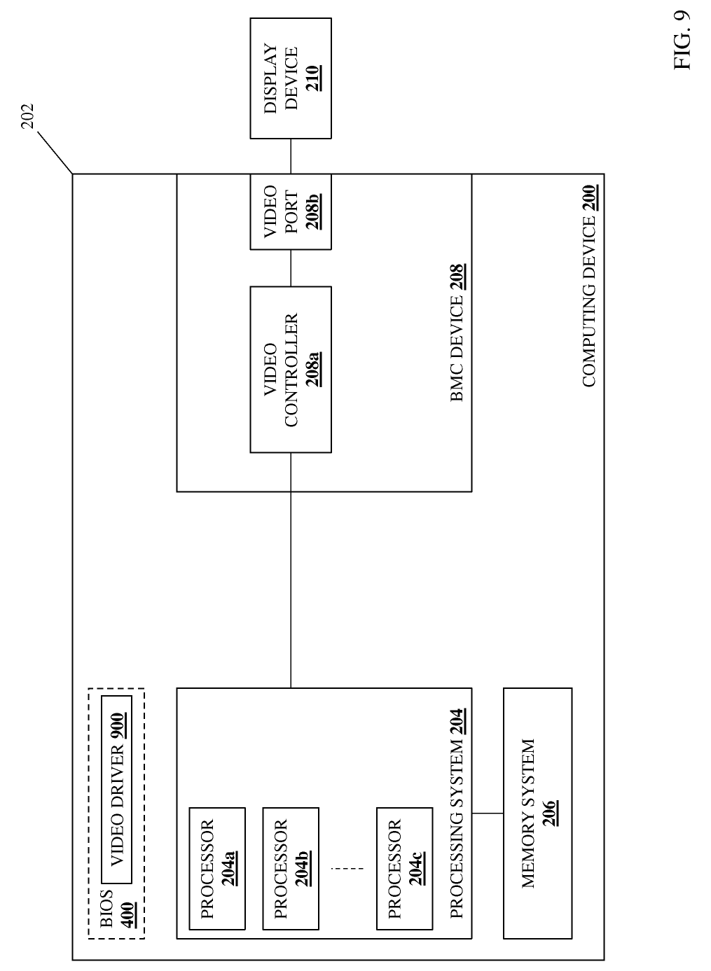

With reference to FIG. 9, in an embodiment of block 308, the BIOS 400 may also perform video driver configuration operations that include using the bus number determined at block 306 to configure a video driver 900 in the BIOS 400 (e.g., by storing the bus number in a BIOS structure) in a manner that one of skill in the art in possession of the present disclosure will appreciate will allow the use of the video driver 900 to access the video controller 208a as described below, and/or performing any other video driver configuration operations that would be apparent to one of skill in the art in possession of the present disclosure.

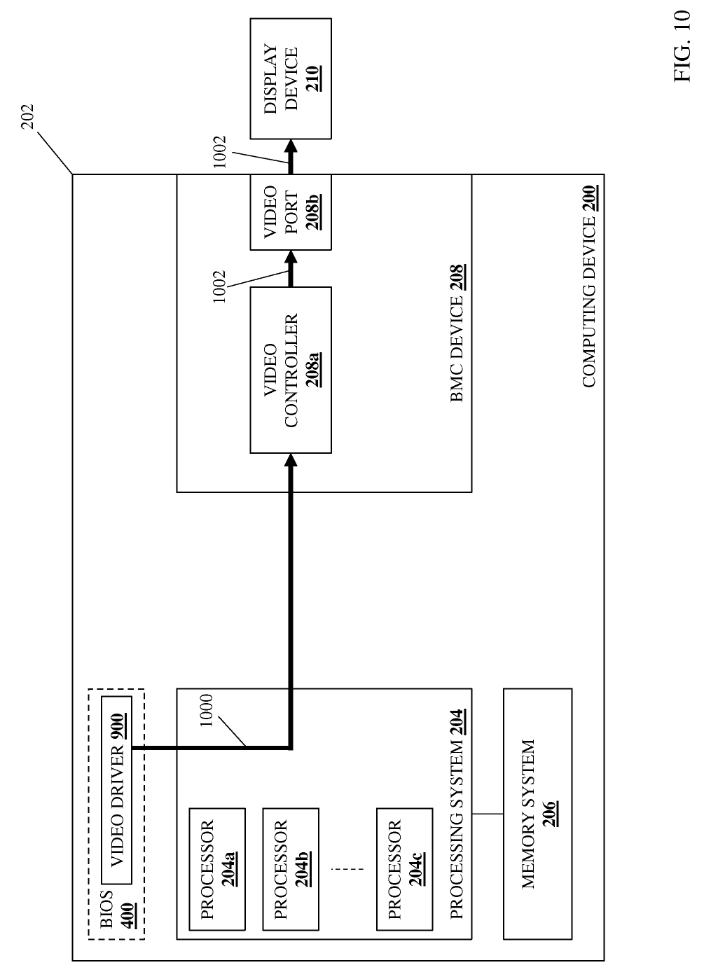

The method 300 then proceeds to block 310 where the BIOS transmits information via the video port using the video controller for display on a display device during the initialization of the computing device. With reference to FIG. 10, in an embodiment of block 310, the BIOS 400 may utilize the video driver 900 to perform information transmission operations 1000 that include generating information during the initialization of the computing device 200 (e.g., information about the status of the initialization of the computing device 200, information requesting instructions for how to proceed with the initialization of the computing device 200, and/or any other information associated with the initialization of the computing device 200 that would be apparent to one of skill in the art in possession of the present disclosure), and transmitting that information to the video controller 208a, and one of skill in the art in possession of the present disclosure will appreciate how the configuration of the video driver 900 and video controller 208a using the bus number at block 308 operates to enable the transmission of the information at block 310.

As illustrated in FIG. 10, the video controller 208a may then perform information display operations 1002 that may include providing the information received via the video driver 900 from the BIOS 400, and providing it via the video port 208b and for display on the display device 210. As will be appreciated by one of skill in the art in possession of the present disclosure, the information provided for display on the display device 210 by the video controller 208a that is “embedded” in the BMC device 208 may be considered “embedded” video. As will be appreciated by one of skill in the art in possession of the present disclosure, the information transmission operations 1000 and the information display operations 1002 may be performed throughout the initialization of the computing device 200 in order to, for example, display any information during the initialization of the computing device 200.

Thus, systems and methods have been described that take advantage of a fixed mapping of a fabric identifier to the connection between a video port and a processor that controls that video port in order to identify a bus number associated with that fabric identifier, and then use that bus number to configure a video controller that is coupled to the video port and that allows information to be transmitted via the video port for display on a connected display device during initialization operations. For example, the initialization video enablement system of the present disclosure may include a processing system coupled to a video port by a video controller. During initialization operations, a Basic Input/Output System (BIOS) provided by the processing system identifies a processor in the processing system that is configured to control the video port. The BIOS then identifies a fabric identifier associated with the connection of the processor to the video port. The BIOS then determines a bus number assigned to the fabric identifier. The BIOS then uses the bus number to configure the video controller. The BIOS then transmits information for display on a display device via the video port using the video controller. As such, video may be dynamically enabled during the initialization of a computing device without having to take into account the different configurations and capabilities of processing systems that are available for utilization with that computing device.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An initialization video enablement system, comprising:
a processing system;
a video port;
a video controller that couples the processing system to the video port; and
a Basic Input/Output System (BIOS) that is provided by the processing system and that is configured, during initialization operations, to:
identify a processor that is included in the processing system and that is configured to control the video port;
identify a fabric identifier that is associated with the connection of the processor to the video port;
determine a bus number that is assigned to the fabric identifier;
configure, using the bus number, the video controller; and
transmit, via the video port using the video controller, information for display on a display device.

2. The system of claim 1, wherein the processor is one of a plurality of processors that are included in the processing system.

3. The system of claim 1, wherein the BIOS is configured, during the initialization operations, to:
configure, using the bus number, a video driver in the BIOS for use in transmitting the information for display in the display device via the video port using the video controller.

4. The system of claim 1, wherein transmitting the information for display on the display device is performed during Pre-Extensible Firmware Interface (EFI) Initialization (PEI) phase of the initialization operations.

5. The system of claim 1, further comprising:
a Baseboard Management Controller (BMC) device that is coupled to the processing system and that includes the video port and the video controller.

6. The system of claim 1, wherein the identifying the fabric identifier that is associated with the connection of the processor to the video port includes:
retrieving the fabric identifier from the processor.

7. An Information Handling System (IHS), comprising:
a processing system; and
a memory system that is coupled to the processing system and that includes instructions that, when executed by the processing system, cause the processing system to provide a Basic Input/Output System (BIOS) that is configured, during initialization operations for the IHS, to:
identify a processor that is included in the processing system and that is configured to control a video port;
identify a fabric identifier that is associated with the connection of the processor to the video port;
determine a bus number that is assigned to the fabric identifier;
configure, using the bus number, a video controller; and
transmit, via the video port using the video controller, information for display on a display device.

8. The IHS of claim 7, wherein the processor is one of a plurality of processors that are included in the processing system.

9. The IHS of claim 7, wherein the BIOS is configured, during the initialization operations, to:
configure, using the bus number, a video driver in the BIOS for use in transmitting the information for display in the display device via the video port using the video controller.

10. The IHS of claim 7, wherein transmitting the information for display on the display device is performed during Pre-Extensible Firmware Interface (EFI) Initialization (PEI) phase of the initialization of the IHS.

11. The IHS of claim 7, wherein the video port and the video controller are included in a Baseboard Management Controller (BMC) device.

12. The IHS of claim 7, wherein the identifying the fabric identifier that is associated with the connection of the processor to the video port includes:
retrieving the fabric identifier from the processor.

13. The IHS of claim 7, wherein the processing system is configured to perform multi-segmentation and bus repurposing.

14. A method for enabling video during initialization of a computing device, comprising:
identifying, by a Basic Input/Output System (BIOS) during initialization of a computing device, a processor that is included in a processing system and that is configured to control a video port;
identifying, by the BIOS during the initialization of the computing device, a fabric identifier that is associated with the connection of the processor to the video port;
determining, by the BIOS during the initialization of the computing device, a bus number that is assigned to the fabric identifier;
configuring, by the BIOS during the initialization of the computing device using the bus number, a video controller; and
transmitting, by the BIOS during the initialization of the computing device via the video port using the video controller, information for display on a display device.

15. The method of claim 14, wherein the processor is one of a plurality of processors that are included in the processing system.

16. The method of claim 14, further comprising:
configure, by the BIOS during the initialization of the computing device using the bus number, a video driver in the BIOS for use in transmitting the information for display in the display device via the video port using the video controller.

17. The method of claim 14, wherein transmitting the information for display on the display device is performed during Pre-Extensible Firmware Interface (EFI) Initialization (PEI) phase of the initialization of the computing device.

18. The method of claim 14, wherein the video port and the video controller are included in a Baseboard Management Controller (BMC) device.

19. The method of claim 14, wherein the identifying the fabric identifier that is associated with the connection of the processor to the video port includes:
retrieving the fabric identifier from the processor.

20. The method of claim 14, wherein the processing system is configured to perform multi-segmentation and bus repurposing.
